(19) United States
(12) Patent Application Publication
(10) Pub. No.: US 2021/0254225 A1
(43) Pub. Date: Aug. 19, 2021

(54) PHOTOELECTRODE FOR HYDROGEN GENERATION IN SOLAR WATER SPLITTING AND MANUFACTURING METHOD THEREOF

(71) Applicant: KOREA INSTITUTE OF SCIENCE AND TECHNOLOGY, Seoul (KR)

(72) Inventors: Dong Ki LEE, Seoul (KR); Byoung Koun MIN, Seoul (KR); Byungwoo KIM, Seoul (KR); Yun Jeong HWANG, Seoul (KR); Hyung-Suk OH, Seoul (KR); Ung LEE, Seoul (KR); Jai Hyun KOH, Seoul (KR)

(21) Appl. No.: 16/804,001

(22) Filed: Feb. 28, 2020

(30) Foreign Application Priority Data
Feb. 13, 2020 (KR) 10-2020-0017903

(51) Int. Cl. C25B 1/00; C25B 9/04; C25B 11/04; H01M 14/00

(52) U.S. Cl. CPC C25B 1/003; H01M 14/005; C25B 11/0405; C25B 9/04

(57) ABSTRACT

Provided are a photoelectrode for hydrogen generation in solar water splitting and a manufacturing method thereof. The photoelectrode for hydrogen generation in solar water splitting, includes a light absorbing layer including a chalcopyrite compound; and a hydrogen generation catalyst including CuₓS (where 0≤x≤2) which is present on the light absorbing layer, and may be manufactured by using a solution process which enables mass production and produce hydrogen from water using sunlight with high efficiency without using a noble metal element.

### CROSS-REFERENCE TO RELATED APPLICATION

This application claims the benefit of Korean Patent Application No. 10-2020-0017903, filed on Feb. 13, 2020, in the Korean Intellectual Property Office, the disclosure of which is incorporated herein in its entirety by reference.

### BACKGROUND

### 1. Field

The disclosure relates to a photoelectrode for hydrogen generation in solar water splitting and a manufacturing method thereof.

### 2. Description of the Related Art

Hydrogen is a typical clean fuel and is expected to show great increases in usage according to the supply of hydrogen vehicles, but recent commercialized methods for preparing hydrogen have defects of emitting a large amount of carbon dioxide. For example, if 1 kg of hydrogen is produced by a methane gas steam reforming method, 10 kg of carbon dioxide is produced as a by-product.

The technique of hydrogen generation through solar water splitting is technique which is capable of producing hydrogen cleanly without generating by-products such as carbon dioxide by using sunlight and water as raw materials. Accordingly, solar water splitting technique using various photoelectrodes has been studied but has troubles in commercialization, because an expensive preparation method and a high-priced noble metal catalyst element are required.

Accordingly, the development of a photoelectrode which is capable of producing hydrogen from water using sunlight with high efficiency by a manufacturing method in large quantities without using a noble metal element, is required.

### SUMMARY

An aspect of an embodiment is to provide a photoelectrode which may be manufactured using a solution process facilitating mass production and may produce hydrogen from water using sunlight with high efficiency without using a noble metal element.

Another aspect of an embodiment is to provide a solar cell including the photoelectrode.

Another aspect of an embodiment is to provide a method of manufacturing the photoelectrode.

Additional aspects will be set forth in part in the description which follows and, in part, will be apparent from the description, or may be learned by practice of the presented embodiments of the disclosure.

According to an aspect, a photoelectrode for hydrogen generation in solar water splitting, including a light absorbing layer including a chalcopyrite compound; and a hydrogen generation catalyst including CuₓS (where 0<x≤2) which is positioned on the light absorbing layer are provided.

According to another aspect, a solar cell including the photoelectrode for hydrogen generation in solar water splitting, is provided.

According to another aspect, there is provided a method of manufacturing a photoelectrode for hydrogen generation, including:

applying a metal precursor paste on a substrate and first heat treating to form a metal hydroxide or oxide thin film;

second heat treating the metal hydroxide or oxide thin film under a mixture atmosphere of a gaseous sulfur precursor and a selenium precursor to form a light absorbing layer of a chalcopyrite compound, wherein CuₓS (where 0<x≤2) and Cu_{y}Se (where 0<y≤2) are present on a surface of the light absorbing layer; and

additional heat treating while maintaining a temperature of the second heat treatment under a sulfur precursor atmosphere while blocking the selenium precursor to form a hydrogen generation catalyst, wherein only CuₓS (where 0<x≤2) is present on the surface of the light absorbing layer,

wherein the metal precursor paste includes a metal precursor containing a copper (Cu) element, and the copper (Cu) element is included in a sufficient amount for forming the CuₓS (where 0<x≤2) on the surface of the light absorbing layer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a mimetic diagram showing a schematic cross-sectional structure of a photoelectrode according to an embodiment.

FIG. 2 is a mimetic diagram explaining the manufacturing process of the conventional CIGSSe series photoelectrode.

FIG. 3 is a mimetic diagram explaining the manufacturing process of a photoelectrode according to an embodiment.

FIG. 4 is a SEM image of the cross-section of the photoelectrode manufactured in Example 1.

FIG. 5 shows the element distribution diagram of Cu/(In+Ga) according to a depth from the surface of the photoelectrode manufactured in Example 1 in contrast to Comparative Example 2.

FIG. 6 shows the element distribution diagram of S/(S+Se) according to a depth from the surface of the photoelectrode manufactured in Example 1.

FIG. 7 shows Raman analysis results using the photoelectrode of Example 1. This is for examining the structure of a CuₓS layer in electrochemical hydrogen generation (HER) conditions.

FIG. 8 shows a graph comparing the cut current density-potential (J-V) curves of the photoelectrodes manufactured in Example 1 and Comparative Example 1.

FIG. 9 shows the measurement results of photocurrent density-time plots and faraday efficiency on the hydrogen generation of the photoelectrode of Example 1.

FIG. 10 shows the time-resolved photoluminescence (TRPL) plots of the photoelectrodes manufactured in Example 1 and Comparative Example 1.

FIG. 11 shows the measurement results of incident photon to current efficiency (IPCE) according to the wavelength of light incident to the photoelectrode manufactured in Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present inventive concept described below may be modified in various forms and have many embodiments, and particular embodiments are illustrated in the drawings and described in detail in the detailed description. However, the present inventive concept should not be construed as limited to the particular embodiments, but should be understood to cover all modifications, equivalents or replacements included in the technical scope of the present inventive concept.

The terminology used herein is for the purpose of explaining particular embodiments only and is not intended to limit the present inventive concept. The singular forms include the plural forms as well, unless the context clearly indicates otherwise. It will be further understood that the terms “comprise” or “comprising” when used herein, specify the presence of stated features, numbers, steps, operations, elements, parts, components, materials, or combinations thereof, but do not preclude the presence or addition of one or more other features, numbers, steps, operations, elements, parts, components, materials, or combinations thereof.

In the drawings, the thicknesses of layers and regions are enlarged or reduced for clear explanation. The same reference numerals are marked for similar elements throughout. When a layer, film, region, plate, or the like is referred to as being “on” another part, it can be directly on the other part, or intervening parts may be present. The terms “first”, “second”, and the like may be used for describing various elements throughout, but the elements are not limited by the terms. The terms are used to only distinguish one element from other elements.

It will be understood that, although the terms first, second, etc. may be used herein to described various elements, components, regions, layers and/or areas, these elements, components, regions, layers and/or areas should not be limited by these terms.

In addition, processes explained in the disclosure are not always applied in order. For example, if a first step and a second step are described, it will be understood that the first step is not always performed prior to the second step.

Hereinafter, a photoelectrode for hydrogen generation in solar water splitting and a manufacturing method thereof will be explained in detail referring to drawings.

A photoelectrode for hydrogen generation in solar water splitting according to an embodiment includes:

a light absorbing layer including a chalcopyrite compound; and

a hydrogen generation catalyst including CuₓS (where 0<x≤2) which is positioned on the light absorbing layer.

The photoelectrode for hydrogen generation in solar water splitting according to an embodiment may be manufactured excluding noble metals and using only cheap elements and a solution process facilitating mass production, and the performance of photovoltaic hydrogen production may be maximized by optimizing the interface junction between the photoelectrode and a water splitting catalyst layer.

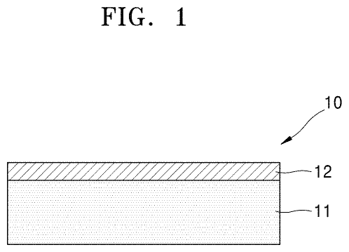

FIG. 1 is a mimetic diagram showing the schematic cross-sectional structure of a photoelectrode according to an embodiment.

As shown in FIG. 1, a photoelectrode 10 according to an embodiment has a stacked structure of a light absorbing layer 11 and a hydrogen generation catalyst 12 in order. In FIG. 1, the hydrogen generation catalyst 12 is shown in a layered shape but is only an embodiment, and the hydrogen generation catalyst may be present on the surface of the light absorbing layer in a CuₓS (where 0<x≤2) phase itself, may have a particulate shape composed of CuₓS (where 0<x≤2), may have a single layer shape composed of CuₓS (where 0<x≤2), or may also have a combination shape thereof.

The photoelectrode 10 is used in a state where the hydrogen generation catalyst 12 makes direct contact with the surface of the light absorbing layer 11, and no additional layer is present on the hydrogen generation catalyst 12. Since only the hydrogen generation catalyst 12 including CuₓS is present on the surface of the light absorbing layer 11, the photoelectrode 10 may minimize the loss of incident light and increase the efficiency of the photoelectrode.

The chalcopyrite compound may include an inorganic compound having a chalcopyrite crystal structure composed of elements in groups. The inorganic compound may include elements in group IB, group IIIA and group VIA. The element in group IB may include copper (Cu), the element in group IIIA may include at least one of indium (In) and gallium (Ga), and the element in group VIA may include at least one of selenium (Se) and sulfur (S).

According to an embodiment, the chalcopyrite compound may include at least one inorganic compound among copper indium selenide (CISe)-based, copper indium gallium selenide (CIGS)-based, copper indium sulfide (CIS)-based, copper indium gallium sulfide (CIGS)-based and copper indium gallium sulfur selenide (CIGSSe)-based compounds. For example, the inorganic compound having a chalcopyrite crystal structure may be a copper indium gallium sulfur selenide (CIGSSe)-based compound represented by CuInₓGa₍₁₋ₓ₎S_{y}Se_{(2-y)} (where 0<x<1 and 0<y<2).

The light absorbing layer may have a single layer or a multilayer structure of two or more layers. The total thickness of the light absorbing layer may be in a range of about 0.01 μm to about 20 μm, for example, a range of about 0.1 μm to about 5 μm, or a range of about 0.5 μm to about 3 μm. Within the above-described range, improved optical properties may be shown.

The hydrogen generation catalyst including CuₓS (where 0<x≤2) is positioned on the light absorbing layer. A CuₓS material is used as the hydrogen generation catalyst. The hydrogen generation catalyst may be present on the surface of the light absorbing layer in a CuₓS (where 0<x≤2) phase itself, may have a particulate shape composed of CuₓS (where 0<x≤2), may have a single layer shape composed of CuₓS (where 0<x≤2), or may be a combination shape thereof.

By forming the hydrogen generation catalyst including CuₓS on the light absorbing layer, a photoelectrode which is capable of splitting water and producing hydrogen using sunlight with high efficiency may be manufactured using only cheap elements excluding noble metals.

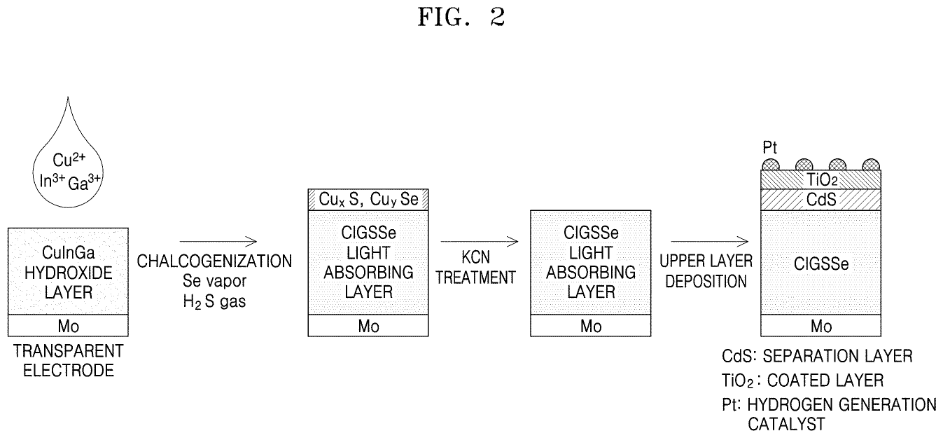

Generally, the conventional photoelectrode has a structure obtained by depositing a light absorbing layer, a CdS separation layer, a TiO₂ coated layer, and a Pt catalyst layer in order on a substrate. For example, in case of the conventional CIGSSe series photoelectrode, as shown in FIG. 2, a CIGSSe light absorbing layer is formed by depositing a CuInGa composite hydroxide film on a Mo substrate and performing chalcogenization treatment (S and Se treatment), and a mixed layer of CuₓS and Cu_{y}Se is naturally formed on the surface of the light absorbing layer as the by-products of the chalcogenization treatment. After removing such a by-product layer through the treatment with a KCN solution, a CdS separation layer, a TiO₂ coated layer, and a Pt hydrogen generation catalyst are deposited in order to finally complete a photoelectrode composed of CIGSSe/CdS/TiO₂/Pt.

However, light incident to the conventional photoelectrode is partially damaged by the CdS, TiO₂, and Pt layers, and on the contrary, the loss of light incident to the photoelectrode according to an embodiment may be minimized and the efficiency of the photoelectrode may be increased, because only a CuₓS hydrogen generation catalyst is present on the surface of the light absorbing layer.

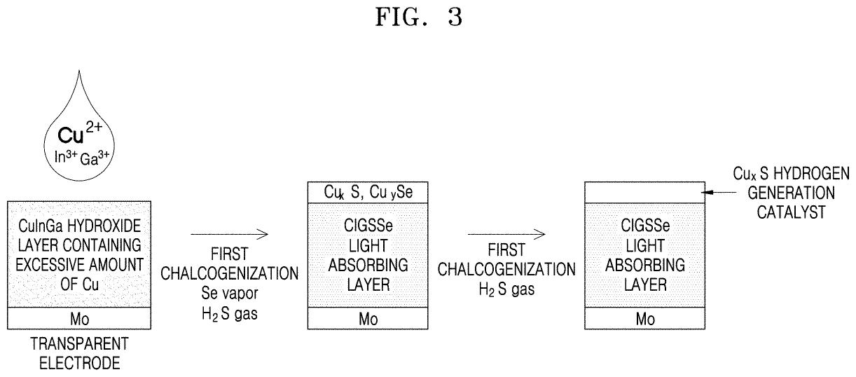

The hydrogen generation catalyst including CuₓS may be, for example, naturally deposited during the manufacturing process of the light absorbing layer on the surface thereof. For example, as shown in FIG. 3, in order to uniformly deposit only the CuₓS hydrogen generation catalyst on the surface of the light absorbing layer, the Cu content in CuInGa composite hydroxide is an excess in contrast to the common content used, and a second chalcogenization process injecting only S is additionally performed after performing the first chalcogenization by which S and Se are mixed and injected. Through this, the CuₓS hydrogen generation catalyst is uniformly formed on the surface of the light absorbing layer, thereby serving a photoelectrode showing hydrogen production in photoelectrochemical water splitting with high efficiency without performing additional deposition of the conventional CdS separation layer, TiO₂ coated layer, and Pt hydrogen generation catalyst.

The hydrogen generation catalyst composed of the CuₓS (where 0<x≤2) is in a state of making direct contact on the surface of the light absorbing layer and is used for water splitting without including any additional layer on the light absorbing layer.

According to an embodiment, the hydrogen generation catalyst may have a particulate shape composed of CuₓS (where 0<x≤2). The particle size may be, for example, in a range of about 0.1 nm to about 10 nm.

According to an embodiment, the hydrogen generation catalyst may have a single layer shape composed of CuₓS (where 0<x≤2). In case of forming a single layer, a thickness may be, for example, in a range of about 0.1 nm to about 10 nm.

If the particle size or the thickness of the hydrogen generation catalyst is in the above-described range, the amount used of a material may be minimized and the loss of light incident to the light absorbing layer may be minimized, thereby showing improved optical properties.

The photoelectrode may further include a substrate supporting the light absorbing layer.

The substrate may be a conductive substrate in itself, or a nonconductive substrate coated with a conductive material. For example, the substrate may be a conductive substrate including one or two or more among indium tin oxide, fluorine-doped indium tin oxide, glass, molybdenum (Mo)-coated glass, a metal foil, a metal plate, and a conductive polymer, or a nonconductive substrate coated with one or a mixture of two or more among indium tin oxide, fluorine-doped indium tin oxide, glass, molybdenum (Mo)-coated glass, a metal foil, a metal plate and a conductive polymer.

A solar cell according to another embodiment includes the photoelectrode for hydrogen generation in solar water splitting.

According to another embodiment, there is provided a method of manufacturing the photoelectrode for hydrogen generation in solar water splitting by using a solution process.

According to an embodiment, the method of manufacturing a photoelectrode for hydrogen generation in solar water splitting, includes:

applying a metal precursor paste on a substrate and first heat treating to form a metal hydroxide or oxide thin film;

second heat treating the metal hydroxide or oxide thin film under a mixture atmosphere of a gaseous sulfur precursor and a selenium precursor to form a light absorbing layer of a chalcopyrite compound, wherein CuₓS (where 0<x≤2) and Cu_{y}Se (where 0<y≤2) are present on a surface of the light absorbing layer; and

additional heat treating while maintaining a temperature of the second heat treatment under a sulfur precursor atmosphere while blocking the selenium precursor to form a hydrogen generation catalyst, wherein only CuₓS (where 0<x≤2) is present on the surface of the light absorbing layer,

wherein the metal precursor paste includes a metal precursor containing a copper (Cu) element, and the copper (Cu) element is included in a sufficient amount for forming the CuₓS (where 0<x≤2) on the surface of the light absorbing layer.

The metal precursor paste may include a metal precursor, an organic binder and a solvent.

The metal precursor included in the metal precursor paste may include a precursor of one or more metals in group IB including a copper (Cu) element, or a precursor of one or more metals in group IIIA, or a mixture of two or more thereof.

The metal precursor may form the ion of each metal and may be the nitrate, hydrate, chloride, hydroxide, nitrate, sulfate, acetate, chloride, acetylacetonate, formate and oxide of each metal or alloys of two or more metals, and a metal precursor paste may be prepared using the same compound or two or more compounds thereof.

According to an embodiment, the metal precursor may include copper (Cu), indium (In) and gallium (Ga) compounds. For example, the metal precursor may include hydroxides of Cu, In and Ga.

The metal precursor includes an excessive amount of copper (Cu) element based on an amount used for preparing the chalcopyrite compound of a p-type semiconductor in a common solution process. The amount of the copper (Cu) element may be an amount sufficient for forming CuₓS (where 0<x≤2) on the surface of the light absorbing layer. The copper element remaining after forming the chalcopyrite compound of the light absorbing layer using the excessive amount of copper element forms a mixture layer of CuₓS (where 0<x≤2) and Cu_{y}Se (where 0<y<2) on the light absorbing layer, and may form a hydrogen generation catalyst composed of CuₓS (where 0<x≤2) through additional subsequent chalcogenization reaction.

The organic binder included in the metal precursor paste may include, for example, one of ethyl cellulose, polyvinyl acetate, palmitic acid, polyethylene glycol, polypropylene glycol, polypropylene carbonate, and propylenediol, or a mixture of two or more thereof. The organic binder may be included in the metal precursor paste in a range of about 0.1 parts by weight to about 30 parts by weight based on about 100 parts by weight of the metal precursor. Within the above-described range, the cohesion and inner firmness of the chalcopyrite compound in the light absorbing layer may increase.

The solvent included in the metal precursor paste may include, for example, one or two or more among water, methanol, ethanol, propanol, butanol, acetone, dimethyl ketone, propanone, methoxyethane, 1,2-dimethoxyethane, benzene, toluene, xylene, tetrahydrofuran, anisole, hexane, cyclohexane, carbon tetrachloride, methylene chloride and chloroform.

The viscosity of the metal precursor paste may be in a range of about 50 cP to about 1,500 cP. Within the above-described range, the inner firmness and surface planarity of a film when coating a paste may be secured. By controlling the amount of the solvent, the viscosity of the metal precursor paste may be controlled in the above-described range.

The substrate may be a conductive substrate, or a nonconductive substrate coated with a conductive material. For example, the substrate may be a conductive substrate including one or two or more among indium tin oxide, fluorine-doped indium tin oxide, glass, molybdenum (Mo)-coated glass, a metal foil, a metal plate, and a conductive polymer, or a nonconductive substrate coated with one or a mixture of two or more among indium tin oxide, fluorine-doped indium tin oxide, glass, molybdenum (Mo)-coated glass, a metal foil, a metal plate, and a conductive polymer. The substrate may be a transparent substrate.

Prior to applying the metal precursor paste on the substrate, impurities on a surface may be removed through washing the substrate using ultrasonic waves, etc.

On the substrate thus prepared, a metal precursor paste is applied, and first heat treatment is performed to form a metal hydroxide or oxide thin film. The application of the metal precursor paste, and the first heat treatment may be repeatedly performed from once to 20 times. If a multistep coating is applied two or more times, the metal precursor paste prepared using the same or various compositions may be applied. The application may be performed using one or two or more methods among printing, spin coating, roll-to-roll coating, slit die coating, bar coating and spray coating. After applying the metal precursor paste, the first heat treatment may be performed, for example, in the air atmosphere at a temperature of about 250° C. to about 350° C. for about 1 minute to about 60 minutes, and through this, a metal hydroxide or oxide thin film may be formed on the substrate.

For the chalcogenization reaction of the metal hydroxide or oxide thin film thus formed, the metal hydroxide or oxide thin film is second heat treated under a mixture atmosphere of a gaseous sulfur precursor and a selenium precursor (first chalcogenization). Through the first chalcogenization reaction by the second heat treatment, the sulfurization and selenization of the metal hydroxide or oxide thin film are performed to form the light absorbing layer of a chalcopyrite compound which is crystallized into a chalcopyrite structure composed of groups, and the excessive amount of copper (Cu) present is mixed and deposited into CuₓS (where 0<x≤2) and Cu_{y}Se (where 0<y≤2) phases on the surface of the light absorbing layer of the chalcopyrite compound.

Examples of the sulfur precursor may include H₂S, sulfur-containing organic compounds such as alkylthiol (RSH, where R is alkyl of 1 to 10 carbon atoms or carboxyalkyl), thiourea and thioacetamide, or a sulfur (S) element, but is not limited thereto.

Examples of the selenium precursor may include precursors providing anionic or neutral Se ions in a solvent, such as Na₂Se, Na₂SeO₃, Na₂SeO₃.5H₂O and Se, and precursors providing cationic Se ions, such as SeCl₄ and SeS₂, and a selenium (Se) element, but is not limited thereto.

Such sulfurization and selenization may be achieved through heat treatment under a gas atmosphere such as H₂S, S vapor, H₂Se, Se vapor and a mixture gas thereof, and also through heat treatment under a mixture gas atmosphere of the above-described gases with an inert gas. In addition, the sulfurization or selenization may be achieved by preparing vapor using S and Se powders or pellets.

The second heat treatment for a sulfurization and selenization process may be performed in a temperature range of about 50° C. to about 1,500° C., for example, about 400° C. to about 900° C. or about 450° C. to about 600° C. The temperature of the second heat treatment may be higher than the temperature of the first heat treatment. In addition, the second heat treatment may be performed by applying a single temperature mode or a multistep temperature mode. The second heat treatment may be performed by applying a gradual temperature elevating mode. The first chalcogenization reaction by the second heat treatment may be performed, for example, for about 10 minutes to about 60 minutes.

After forming the light absorbing layer of the chalcopyrite compound, additional heat treatment (second chalcogenization) is performed under a sulfur precursor atmosphere while blocking the selenium precursor and maintaining the temperature of the second heat treatment, to substituted Se of Cu_{y}Se present on the surface of the light absorbing layer with S to remain only CuₓS (where 0<x≤2) on the surface of the light absorbing layer. Accordingly, a photoelectrode for hydrogen generation in solar water splitting, including a light absorbing layer, in which a CuₓS (where 0<x≤2) hydrogen generation catalyst is formed on the surface thereof, may be obtained.

The additional heat treatment may be performed while maintaining the elevated temperature in the second heat treatment constantly. The second chalcogenization reaction by the additional heat treatment may be performed, for example, for about 10 minutes to about 60 minutes.

Example embodiments will be explained in more detail through the examples and the comparative examples below. However, the examples and the comparative examples are only for illustrating technical spirits, and the scope of an embodiment is not limited thereto.

### Example 1: Manufacture of Photoelectrode

First, a soda lime glass was washed and then put in a physical deposition equipment, and Mo was deposited to a thickness of 500 nm by a sputtering method to prepare a Mo transparent substrate.

In order to prepare a CIG precursor solution, 0.94 g of Cu(NO₃)₂.xH₂O (99.999%, Aldrich), 1.12 g of In(NO₃)₃.xH₂O (99.99%, Aldrich), and 0.41 g of Ga(NO₃)₃.xH₂O (99.999%, Alfa) were dissolved in a methanol solvent (8.4 mL). Here, the molar ratio of Cu(NO₃)₂, In(NO₃)₃, and Ga(NO₃)₃ was 0.95:0.7:0.3. The molar ratio (0.95) of Cu(NO₃)₂ used herein was higher than the molar ratio (about 0.8 to 0.9) commonly used for preparing CIGS or CIGSSe of a p-type semiconductor. In addition, a binder solution containing 1.0 g of polyvinyl acetate (Aldrich) in 8.6 mL of methanol was added to a CIG precursor solution, a mixture solution was additionally stirred for 1 hour, and impurities were removed using a syringe filter (PTFE, 0.2 μm pore size, Whatman) to complete a CIG precursor paste.

On the Mo transparent substrate, the CIG precursor paste was spin coated and heated at 340° C. for 30 minutes. This procedure was repeated six times to form a CuInGa hydroxide layer into a thickness of about 1 μm on the Mo transparent substrate.

The CuInGa hydroxide layer thus formed was put in a tube furnace including a selenium (Se) pellet, the temperature was elevated to form a Se atmosphere first, and Se and S treatment was performed for 40 minutes while elevating the temperature to 460° C. under a mixture atmosphere of Se vapor and H₂S gas (first chalcogenization). Through this procedure, a CIGSSe light absorbing layer was formed, and a mixed layer of CuₓSe and Cu_{y}S was formed on the surface of the light absorbing layer.

Then, in a state of blocking Se injection while maintaining the temperature of 460° C. at the chalcogenization step, S treatment was continued for 30 minutes while continuously flowing H₂S gas (second chalcogenization). Through the procedure, Se of Cu_{y}S present on the surface of the CIGSSe light absorbing layer was substituted with S to remain only CuₓSe on the surface of the CIGSSe light absorbing layer to finally manufacture a CIGSSe/CuₓS photoelectrode having a double layer structure.

### Comparative Example 1

The photoelectrode manufactured in Example 1 was immersed in an aqueous 15 M KCN solution for 1 minute to perform KCN treatment to selectively remove a CuₓS phase at the surface.

### Comparative Example 2

A photoelectrode was manufactured by performing the same procedure in Example 1 except for controlling the molar ratio of Cu(NO₃)₂, In(NO₃)₃, and Ga(NO₃)₃ to 0.85:0.7:0.3 to manufacture CIGSSe of a common p-type semiconductor.

### Evaluation Example 1: SEM Analysis

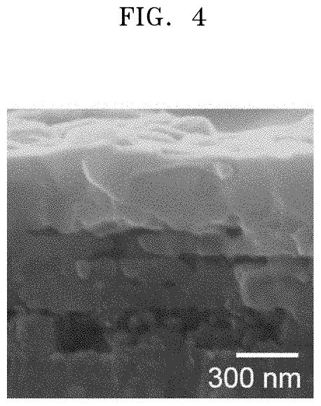

The SEM image of the cross-section of the photoelectrode manufactured in Example 1 is shown in FIG. 4. As shown in FIG. 4, it could be found that the photoelectrode has a layer structure of an upper firmly packed CuₓS layer and a lower CIGSSe layer composed of somewhat porous minute particles formed on a substrate.

### Evaluation Example 2: Analysis on Element Distribution Diagram According to Depth

Element distribution according to the depth of the photoelectrode manufactured in Example 1 was confirmed using an Auger Electron Spectroscopy depth profile.

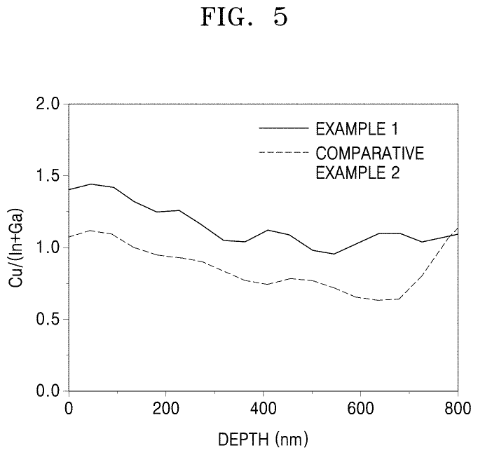

FIG. 5 shows the element distribution diagram of Cu/(In+Ga) according to the depth of the photoelectrode manufactured in Example 1, in comparison with Comparative Example 2.

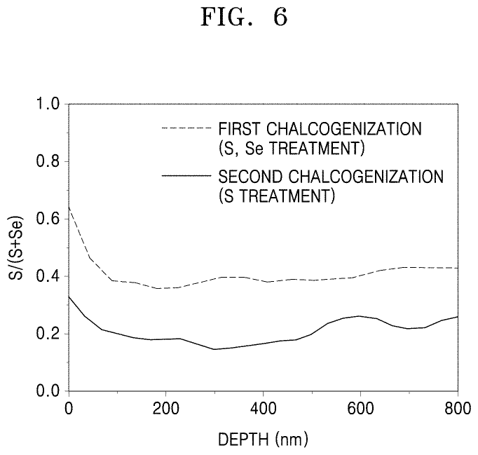

FIG. 6 shows the element distribution diagram of S/(S+Se) according to the depth of the photoelectrode manufactured in Example 1. First chalcogenization and second chalcogenization states were compared.

As shown in FIG. 5 and FIG. 6, it could be found that the photoelectrode manufactured in Example 1 shows higher element ratios of Cu and S at the surface in comparison with other elements according to the formation of a CuₓS layer on the surface of CIGSSe.

### Evaluation Example 3: Raman Analysis

If bulk charge transport properties are supposed to be the same for all CIGSSe films, the surface properties by the presence of CuₓS on the CIGSSe light absorbing layer may be examined by an electrochemical water splitting test in light blocked conditions. This test could be used because the CIGSSe light absorbing layer does not produce additional charge carrier and band bending without lighting, and accordingly, most of the electrochemical properties are dependent on the outermost CuₓS layer. The measurement of the open circuit potential (OCP) of the photoelectrode of Example 1 was performed in a 0.5 M H₂SO₄ solution. In addition, linear-sweep voltammetry (LSV) scan was performed in the same conditions for the light blocked OCP measurement.

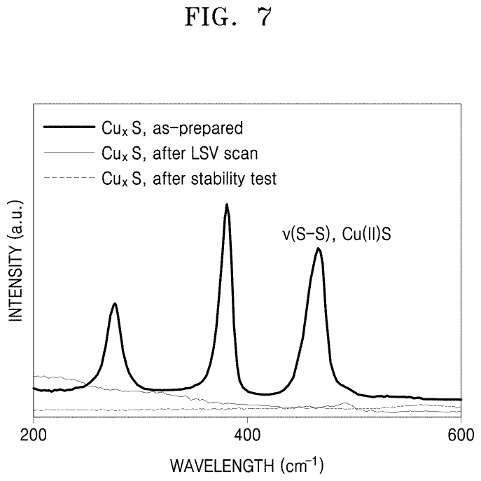

In order to examine the structure of a CuₓS layer under electrochemical hydrogen generation reaction (HER) conditions, Raman analysis was performed using the photoelectrode of Example 1, and the results are shown in FIG. 7.

As shown in FIG. 7, in the photoelectrode of Example 1, CuₓS showed strong Raman peak at 466 cm⁻¹ corresponding to the S—S stretching mode of Cu(II)S. In addition, two sharp peaks were found at 275 cm⁻¹ and 381 cm⁻¹, and these may be generated by the stretching and bending modes of a Cu—S bond in the covellite structure of Cu(II)S. However, the characteristic Raman peak of a Cu(II)S phase disappeared after the LSV scanning of the photoelectrode once. In addition, a reduction peak corresponding to electrochemical reduction was always shown by the first LSV scanning before initiating HER but was not observed any more after second scanning. This shows that the CuₓS layer formed in Example 1 was mainly composed of a Cu(II)S phase, and transformed into Cu(I)₂S in reducible electrochemical conditions in an acid solution.

### Evaluation Example 5: Evaluation of Performance of Photoelectrode

In order to compare the difference of the performance of hydrogen generation in photoelectrochemical water splitting according to the presence/absence of a CuₓS hydrogen generation catalyst, photoelectrochemical water reduction using the photoelectrodes of Example 1 and Comparative Example 1 were performed in a 0.5 M H₂SO₄ solution under the irradiation of air mass of 1.5 G.

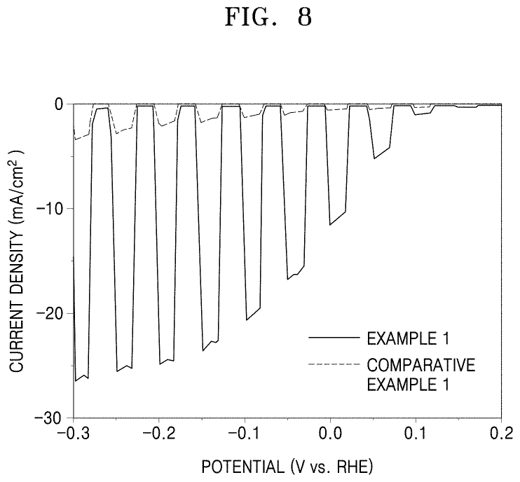

FIG. 8 shows a graph comparing the cut current density-potential (J-V) curves of the photoelectrodes manufactured in Example 1 and Comparative Example 1. CompactStat of Ivium-Technologies Co. in the Netherlands was used as a J-V analysis apparatus, and the analysis was performed in conditions of 1 SUN (100 mW/cm²) utilizing Sun2000 solar simulator of ABET Technologies Co. in the US.

As shown in FIG. 8, it could be found that photocurrent density was rapidly reduced after removing the surface CuₓS as in Comparative Example 1 when compared with the photoelectrode manufactured in Example 1. This shows that the performance improvement of the hydrogen generation in photoelectrochemical water splitting of the photoelectrode of Example 1 is closely related to the Cu and S states of the CIGSSe light absorbing layer. The Cu and S states of the CIGSSe film is mainly induced by the formation of the surface CuₓS layer.

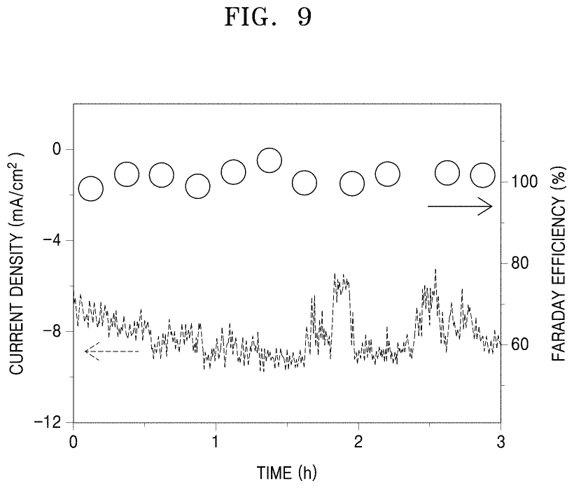

FIG. 9 shows the measurement results of photocurrent density-time plots and faraday efficiency on the hydrogen generation of the photoelectrode of Example 1 in 0 V vs. reversible hydrogen electrode (RHE). As shown in FIG. 9, it could be found that the photoelectrode of Example 1 has high durability on photoelectrochemical hydrogen generation reaction.

In addition, the electron-hole separation properties of the CuₓS hydrogen generation catalyst were evaluated using time-resolved photoluminescence (TRPL) spectroscopy on the photoelectrodes manufactured in Example 1 and Comparative Example 1. By the same method as the photoelectrochemical experiment, the lifespan of photogenerated electrons before and after removing CuₓS was compared.

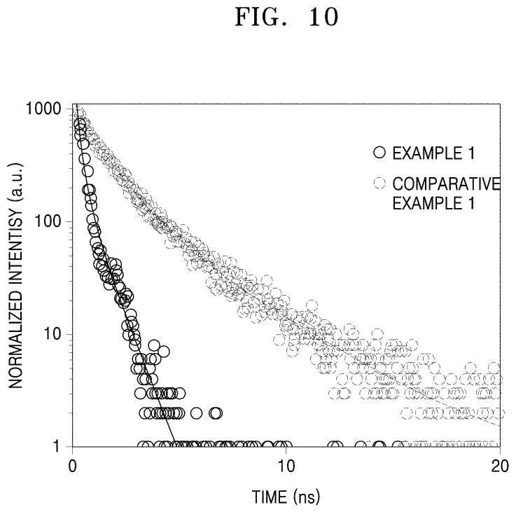

FIG. 10 shows the TRPL plots of the photoelectrodes manufactured in Example 1 and Comparative Example 1. Here, the solid line is a fitted curve. As shown in FIG. 10, the lifespan of the photoelectrodes of Example 1 and Comparative Example 1 was shown 0.09 ns and 1.76 ns, respectively. The decrease of the lifespan of the photoelectrode of Example 1 represents the rapid removal of photogenerated electrons according to the movement from a CIGSSe light absorbing layer to CuₓS. This is another evidence demonstrating the role of CuₓS on the effective light-charge separation of the CIGSSe light absorbing layer.

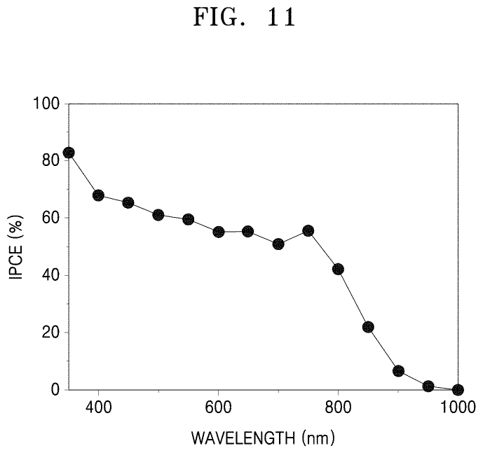

FIG. 11 shows the measurement results of incident photon to current efficiency (IPCE) according to the wavelength of light incident to the photoelectrode manufactured in Example 1. The IPCE analysis was performed by applying the potential of −0.4 V vs. RHE.

As shown in FIG. 11, it could be found that the photoelectrode of Example 1 may use all from the light of about 950 nm corresponding to the band gap of CIGSSe of about 1.3 eV in photocurrent generation. The IPCE curve of FIG. 11 shows rapid absorption from the onset to 750 nm and gradual increase from 350 nm to approximately 80%. Compared with a common photoelectrode, the main difference is the gradual increase of the IPCE curve with respect to a UV region. Generally, since the chalcopyrite photoelectrode used in the common photoelectrochemical water splitting has a CdS upper layer, the CdS layer blocks incident light, and the IPCE curve decreases from 520 nm (2.4 eV, corresponding to the band gap of CdS) to decrease the photocurrent conversion efficiency. On the contrary, since there is no light loss due to a CdS upper layer in the photoelectrode of Example 1, the photocurrent conversion efficiency is excellent when compared with the common photoelectrode.

In order to compare the performance of hydrogen generation in the photoelectrochemical water splitting of the CIGSSe photoelectrodes manufactured by a solution process, the maximum photocurrent density for hydrogen generation of the photoelectrode of Example 1 and the photoelectrodes in reported theses are shown in Table 1 below.

TABLE 1

| | Maximum photocurrent | |
|---|---|---|
| | density for hydrogen | |
| | generation | |
| Photoelectrode configuration | (J/mA · cm⁻²) | Note |
| CIGSSe/CuₓS | −26 | Example 1 |
| CIGSSe/ZnS/Pt | −24 | [1] |
| CuInS₂/CdS/TiO₂/Pt | −14 | [2] |
| Bi:CuInS₂/CdS/TiO₂/Pt | −8 | [3] |
| CuInGaS₂/CdS/Pt | −7 | [4] |
| CuInGaS₂/CdS/C₃N₄₋ₓS_{3x/2} | −5 | [5] |

[1] Chae, S. Y. et al. J. J. Am. Chem. Soc. 2016, 138 (48), 15673-15681.
[2] Zhao, J. et al. Angew. Chem. Int. Ed. 2014, 53 (44), 11808-11812.
[3] Guijarro, N. et al. Adv. Energy Mater. 2016, 6 (7), 1501949-n/a.
[4] Septina, W. et al. J. Phys. Chem. C 2015, 119 (16), 8576-8583.
[5] Wang, D. et al. J. Mater. Chem. A 2017, 5 (7), 3167-3171.

As shown in Table 1, it could be found that the photoelectrode having the configuration of CIGSSe/CuₓS as manufactured in Example 1 showed better performance of hydrogen generation in photoelectrochemical water splitting when compared with other photoelectrodes in related arts.

The photoelectrode for hydrogen generation in solar water splitting according to an embodiment may be manufactured using a solution process which facilitates mass production, and may produce hydrogen from water using sunlight with high efficiency without using a noble metal element.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A photoelectrode for hydrogen generation in solar water splitting, the photoelectrode comprising:
a light absorbing layer comprising a chalcopyrite compound; and
a hydrogen generation catalyst comprising CuₓS (where 0<x≤2) which is present on the light absorbing layer.

2. The photoelectrode of claim 1,
wherein the hydrogen generation catalyst has a particulate shape or a single layer composed of CuₓS (where 0<x≤2), or both thereof.

3. The photoelectrode of claim 1,
wherein the hydrogen generation catalyst makes direct contact with a surface of the light absorbing layer, and no additional layer is present on the light absorbing layer.

4. The photoelectrode of claim 1,
wherein the chalcopyrite compound comprises an inorganic compound having a chalcopyrite crystal structure composed of elements of groups.

5. The photoelectrode of claim 4,
wherein the inorganic compound comprises at least one of copper indium selenide (CISe)-based, copper indium gallium selenide (CIGSe)-based, copper indium sulfide (CIS)-based, copper indium gallium sulfide (CIGS)-based and copper indium gallium sulfur selenide (CIGSSe)-based compounds.

6. The photoelectrode of claim 1,
wherein the photoelectrode further comprises a substrate supporting the light absorbing layer, and
the substrate comprises one kind or two or more kinds among indium tin oxide, fluorine-doped indium tin oxide, glass, molybdenum (Mo)-coated glass, a metal foil, a metal plate and a conductive polymer.

7. A method of manufacturing a photoelectrode for hydrogen generation, the method comprising:
applying a metal precursor paste on a substrate and first heat treating to form a metal hydroxide or oxide thin film;
second heat treating the metal hydroxide or oxide thin film under a mixture atmosphere of a gaseous sulfur precursor and a selenium precursor to form a light absorbing layer of a chalcopyrite compound, CuₓS (where 0<x≤2) and Cu_{y}Se (where 0<y≤2) being present on a surface of the light absorbing layer; and
additional heat treating while maintaining a temperature of the second heat treatment under a sulfur precursor atmosphere while blocking the selenium precursor to form a hydrogen generation catalyst, only CuₓS (where 0<x≤2) being present on the surface of the light absorbing layer,
wherein the metal precursor paste comprises a metal precursor containing a copper (Cu) element, and the copper (Cu) element is comprised in a sufficient amount for forming the CuₓS (where 0<x≤2) on the surface of the light absorbing layer.

8. The method of manufacturing a photoelectrode of claim 7,
wherein the metal precursor paste comprises the metal precursor containing the copper (Cu) element, an organic binder and a solvent.

9. The method of manufacturing a photoelectrode of claim 8,
wherein the metal precursor comprises one or more metal precursors in group IB containing a copper (Cu) element, one or more metal precursors in group IIIA, or mixtures thereof, and an amount of the copper (Cu) element is an excessive amount in comparison with a stoichiometric quantity of the chalcopyrite compound of the light absorbing layer.

10. The method of manufacturing a photoelectrode of claim 8,
wherein the metal precursor comprises hydroxides of copper (Cu), indium (In) and gallium (Ga).

11. The method of manufacturing a photoelectrode of claim 7,
wherein the application of the metal precursor paste and the first heat treatment are performed from once to 20 times, and
the first heat treatment is performed in an air atmosphere at a temperature of about 250° C. to about 350° C. for about 1 minute to about 60 minutes.

12. The method of manufacturing a photoelectrode of claim 7,
wherein the application is performed by one method of printing, spin coating, roll-to-roll coating, slit die coating, bar coating and spray coating, or by two or more thereof.

13. The method of manufacturing a photoelectrode of claim 7,
wherein a temperature of the second heat treatment is from about 50° C. to about 1,500° C.

14. The method of manufacturing a photoelectrode of claim 7,
wherein the second heat treatment in the mixture atmosphere of the sulfur precursor and the selenium precursor is performed by applying a gradual temperature elevating mode, and the additional heat treatment under the sulfur precursor atmosphere while blocking the selenium precursor is performed at a constant temperature.
